(19) United States
(12) Patent Application Publication
(10) Pub. No.: US 2011/0291579 A1
(43) Pub. Date: Dec. 1, 2011

(54) DISCHARGE LAMP STARTING CIRCUIT AND DISCHARGE LAMP LIGHTING DEVICE

(75) Inventors: Takumi Horikawa, Tokyo (JP); Akihiko Oohira, Tokyo (JP); Kikuro Sasayama, Tokyo (JP)

(73) Assignee: TDK-LAMBDA CORPORATION, Tokyo (JP)

(21) Appl. No.: 13/150,787

(22) Filed: Jun. 1, 2011

(30) Foreign Application Priority Data
Jun. 1, 2010 (JP) 2010-126301

(51) Int. Cl. H05B 41/24

(52) U.S. Cl. 315/239

(57) ABSTRACT

The present invention is capable of continuously applying an optimum starting waveform to a discharge lamp using a simple-enough circuit configuration. A starting circuit is connected to output terminals of an inverter, and the starting circuit outputs to a discharge lamp an output voltage Vout capable of starting the discharge lamp that is a load, upon receiving an AC power with a high frequency from the inverter at the start of the discharge lamp. Further, the starting circuit is connected to output terminals of the inverter, and comprises two windings connected to the output terminals of the inverter and serially connected to the discharge lamp; a first capacitor connected between an output terminal of the first winding and an input terminal of the second winding; and a second capacitor connected between an input terminal of the first winding and an output terminal of the second winding.

### BACKGROUND OF THE INVENTION

1. Field of the invention

The present invention relates to a discharge lamp starting circuit and a discharge lamp lighting device, which can provide a discharge lamp with an optimal starting waveform at the start of the discharge lamp using a simple-enough circuit configuration.

2. Description of the Related Art

Recently, a start-up voltage for lighting a lamp at its lighting start-up has become low owing to the development in technique for a lamp as a discharge lamp. As a result, a waveform required in the discharge lamp lighting device at its start-up has undergone changes.

Conventional discharge lamps need a high voltage as high as around 15 kV at the lighting start-up and hence a discharge lamp lighting device also needs to be designed, accordingly. By encapsulating krypton or the like inside a discharge lamp, however, a voltage required for the lighting start-up has decreased to around 3 to 5 kV. Further, a discharge lamp lighting device capable of continuously generating a pulse voltage around 1 to 2k V has been required in order to meet new needs.

In association with such a decrease in lighting start-up voltage of a discharge lamp, the conventional lighting devices have met the above-mentioned needs by applying and developing the conventional high-frequency start-up system. Specifically, as disclosed in Japanese patent publication No. 2006-513539, with the conventional circuit system unchanged, the frequency of an inverter at the lighting start-up is allowed to sequentially change and to match the frequency of the inverter to a resonant frequency of each circuit part so as to temporarily obtain a desired pulse voltage, or otherwise, a new circuit is added to the original one to realize the desired pulse voltage.

### SUMMARY OF THE INVENTION

According to the foregoing technique proposed by Japanese unexamined patent application publication No. 2006-513539, it is possible to obtain the desired pulse voltage meeting the discharge lamp. Such desired voltage, however, cannot be continuously obtained therefrom. Further, since an inverter is allowed to operate at high frequencies on the order of 70 kHz to 200 kHz and besides generate a high voltage, there arises a concern about safety in view of resonance frequency variation attributable to the variation in properties of parts. Furthermore, when adding a new circuit, there occurs the problem that the cost is likely to increase by just that much.

Therefore, with the view of the problems described above, it is an object of the present invention to provide a discharge lamp starting circuit and a discharge lamp lighting device, which can continuously apply a starting waveform optimal to a discharge lamp using a simple-enough configuration.

In order to attain the object described above, a discharge lamp starting circuit according to the present invention is one which is connected with an output circuit for outputting an AC power and receives the AC power from the output circuit to output, to the discharge lamp, an output voltage capable of starting the discharge lamp. The discharge lamp starting circuit includes first and second windings connected in series with the discharge lamp as well as being connected with output terminals of the output circuit, and at least two first and second capacitors connected with the terminals of the windings in such a manner that the charging polarity of each of the capacitors connected with each of input terminals of the windings is opposite to that of each of the capacitors connected with each of output terminals of the windings.

Further, the discharge lamp lighting device according to the present invention is equipped with an output circuit for outputting AC power, and a discharge lamp starting circuit for receiving the AC power from the output circuit to output, to the discharge lamp, an output voltage capable of starting the discharge lamp. The discharge lamp starting circuit comprises first and second windings connected in series with the discharge lamp as well as being connected with output terminals of the output circuit, a first capacitor connected between an output terminal of the first winding and an input terminal of the second winding, and a second capacitor connected between an input terminal of the first winding and an output terminal of the second winding.

In these discharge lamp starting circuit and discharge lamp lighting device, the AC power is desirably output from the output circuit as a rectangular waveform AC voltage alternately switching between positive and negative polarities.

Further, in that case, the first and second windings and the first and second capacitors are desirably selected so that after switching of the AC voltage in polarity, both the voltage differences between input sides and output sides of the first and second windings become zero and thereafter the AC voltage again switches in polarity.

Further, the output circuit is desirably configured so that the frequency of the AC power output at the start of the discharge lamp becomes higher than that of the AC power output in the steady state of the discharge lamp.

Furthermore, the first and second windings are desirably wound around the common magnetic core to form an additive polarity transformer.

According to the present invention, at the moment the polarity of the AC power applied from the output circuit to the discharge lamp starting circuit has been reversed, the capacitor attempts to maintain the voltage charged therein up to that time and therefore the charged voltage of the capacitor itself is added to the AC voltage output from the output circuit, enabling an output voltage higher than the AC voltage to be applied instantaneously to the discharge lamp. By continuously applying the AC voltage from the output circuit to the discharge lamp for a given length of time, the output voltage capable of lighting the discharge lamp can be continuously generated from the discharge lamp starting circuit, thus improving the lighting performance of the discharge lamp. Accordingly, the need for such a charging and discharging circuit as was conventionally used is eliminated and besides an optimal starting waveform can be continuously applied to the discharge lamp using a simple-enough circuit configuration with only the first and second capacitors added.

Further, by outputting the AC voltage output from the output circuit as the rectangular waveform AC voltage alternately switching between positive and negative polarities, an output voltage higher than the foregoing AC voltage can be applied instantaneously to the discharge lamp immediately after the foregoing AC voltage has switched in polarity.

Furthermore, by suitably selecting the first and second windings and the first and second capacitors, the first and second capacitors can be charged with the same voltage as the foregoing AC voltage before the AC voltage switches again in polarity. Hence, every time the AC voltage switches in polarity, an output voltage three times larger than the AC voltage can be unfailingly and instantaneously applied to the discharge lamp.

Moreover, in the steady state after the start of the discharge lamp, the frequency of the AC power from the output circuit decreases and therefore the influence of the discharge lamp starting circuit can be neglected, thus enabling the discharge lamp to continue to stably light up.

Further, the first and second windings are wound not around separate magnetic cores but around the common magnetic core to form an additive polarity transformer. Hence, the discharge lamp starting circuit can be compactly formed.

### BRIEF DESCRIPTION OF THE DRAWINGS

These objects and other objects and advantages of the present invention will become more apparent upon reading of the following detailed description and the accompanying drawings in which:

FIG. 1 is a circuit diagram illustrating an overall configuration of a discharge lamp lighting device in one embodiment of the present invention.

FIG. 2 is an equivalent circuit diagram illustrating the behavior at the start of a discharge lamp in one embodiment of the present invention.

FIG. 3 is an equivalent circuit diagram illustrating the behavior at the start thereof in one embodiment of the present invention.

FIG. 4 is an equivalent circuit diagram illustrating the behavior at the start thereof in one embodiment of the present invention.

FIG. 5 is an equivalent circuit diagram illustrating the behavior at the start thereof in one embodiment of the present invention.

FIG. 6 is a circuit diagram illustrating a configuration of a discharge lamp lighting device in the conventional example.

### DETAILED DESCRIPTION OF THE INVENTION

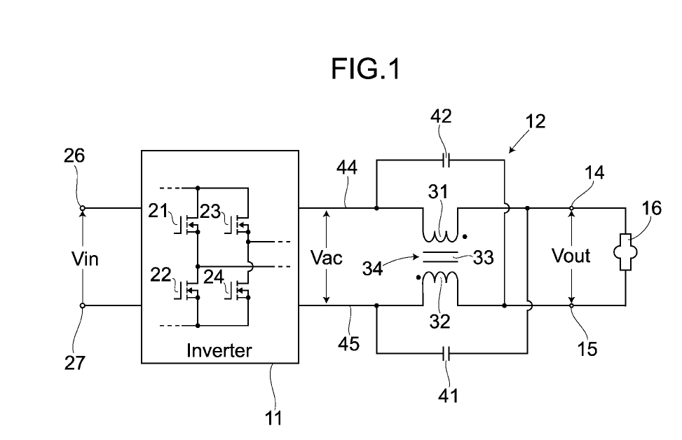

Hereunder is a description of a preferred embodiment according to the present invention with reference to the accompanying drawings. FIG. 1 shows a circuit configuration of a discharge lamp lighting device in the present embodiment. In FIG. 1, numeral symbol 11 denotes an inverter acting as an output circuit for converting direct-current power into AC power to output the AC power. Numeral symbol 12 denotes a starting circuit connected with the output terminals of the inverter. A discharge lamp 16 acting as a load is connected across the output terminals 14, 15 of the starting circuit 12, eventually the discharge lamp lighting device. The inverter 11 is made up of, e.g., four switching elements 21 to 24 full-bridge connected with one another. A pulse drive signal is applied to each of the four switching elements 21 to 24 and thereby a direct-current input voltage Vin applied from input terminals 26, 27 to the inverter 11 is converted into an AC voltage Vac of, e.g., some 400 V to output the AC voltage Vac to the starting circuit 12. Additionally, a variety of semiconductor elements such as IGBTs or the like in addition to MOSFETs can be used as the switching elements 21 to 24.

The starting circuit 12 receives the AC voltage Vac from the inverter circuit 11 to generate and output such a high voltage Vout as to allow the discharge lamp 16 to start, across the output terminals 14, 15. Here, the starting circuit 12 comprises an additive polarity transformer 34 with two substantially equal first and second windings 31, 32 wound around their common magnetic core, a first capacitor 41, and a second capacitor 42. The first winding 31 is connected with the intermediary portion of a first polarity line 44 extending from one output terminal of the inverter 11 to the output terminal 14, while the second winding 32 is connected with the intermediary portion of a second polarity line 45 extending from the other output terminal of the inverter 11 to the output terminal 15. Further, the two capacitors 41, 42 are connected, in such a manner as to straddle crisscross the additive polarity transformer 34, with the terminals of the windings 31, 32 so that the charging polarity of each of the capacitors 41, 42 is apposite to each other when the starting circuit 12 operates, eventually a polarity of voltage on the input side of the starting circuit 12 is temporarily opposite to that on the output side of the starting circuit 12 at the moment when a polarity of the AC voltage Vac from the inverter circuit 11 has been reversed. Specifically, on the input side of the starting circuit 12, the no-dot terminal of the winding 31 and one terminal of the capacitor 42 are connected with one output terminal of the inverter 11, and the dot terminal of the winding 32 and one terminal of the capacitor 41 are connected with the other output terminal of the inverter 11, while on the output side of the starting circuit 12, the dot terminal of the winding 31 and the other terminal of the capacitor 41 are connected with the output terminal 14 and the no-dot terminal of the winding 32 and the other terminal of the capacitor 42 are connected with the other output terminal 15.

In FIG. 1, one additive polarity transformer 34 is included in the starting circuit 12. The windings 31, 32, however, are not necessarily wound around the common magnetic core 33. The windings 31, 32, e.g., can be each prepared as an independent inductive element. In this case, of course, the two capacitors 41, 42 should be mutually crisscross connected in such a manner that the charging polarity of each of the capacitors 41, 42 is opposite to each other when the starting circuit 12 operates. When the capacitors 41, 42 are each 10 pF to 10, 000 pF in capacity, the discharge lamp 16 is allowed to light and then in the steady state where the frequency of the AC voltage Vac from the inverter 11 has decreased to a lower one than that at the start of the discharge lamp 16, a negligible value of the capacity is selected.

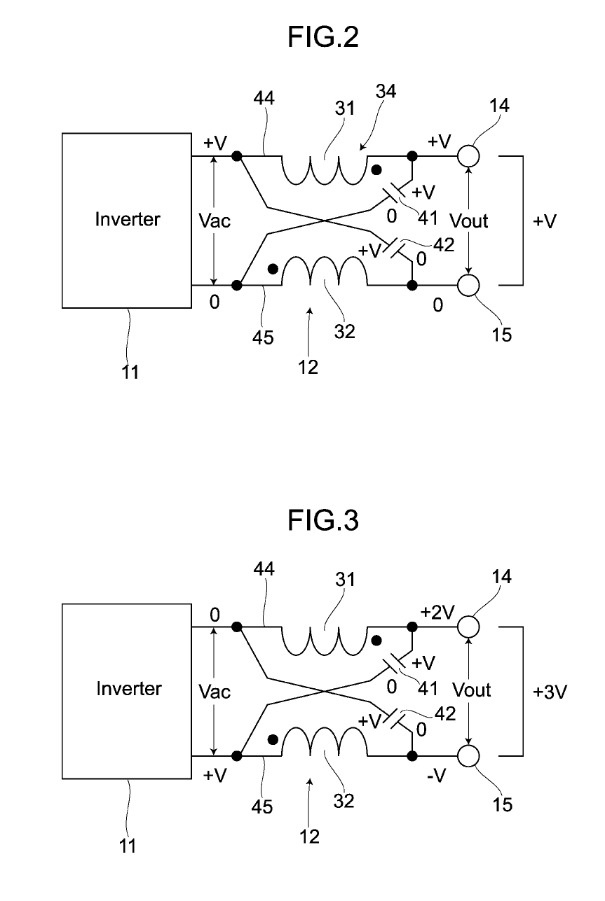

Next is a description of the behavior of the foregoing scheme based on FIG. 2 to FIG. 5. At the start of the discharge lamp 16, when a pulse drive signal with a higher frequency than that in the steady state is applied from a control circuit not shown to the switching elements 21 to 24, the switching elements 21, 24 paired and the switching elements 22, 23 paired alternately turn on and off to generate a rectangular-wave AC voltage Vac alternately switching between negative and positive polarities at the output terminals of the inverter 11.

Here, as shown in FIG. 2, in an initial state immediately after the start, with the other output terminal (the output terminal connected with the second polarity line 44) of the inverter 11 defined as a reference voltage, a voltage +V is assumed to be generated in one output terminal of the inverter 11. The discharge lamp 16 can be deemed to be in an open state until the discharge lamp 16 has been allowed to transfer to light. Further, the windings 31, 32 are allowed to be in an open state immediately after a polarity of the AC voltage Vac from the inverter 11 has been reversed. Thereafter, however, the windings 31, 32 are allowed to transfer to a short-circuit state. Then, the first capacitor 41 is charged at the voltage +V in a case where a voltage of its terminal connected with the second polarity line 45 is a reference voltage, while the second capacitor 42 is charged at the voltage −V in a case where a voltage of its terminal connected with the first polarity line 44 is a reference voltage. At this time, across the output terminals 14, 15, an output voltage Vout of +V is generated, in a case where voltage of the output terminal 15 is a reference voltage.

Later, as shown in FIG. 3, when the polarity of the AC voltage Vac from the inverter 11 has been reversed, a voltage +V is generated in the other output terminal (the output terminal connected with the second polarity line 45) of the inverter 11 with the one output terminal (the output terminal connected with the first polarity line 44) of the inverter 11 whose a voltage is a reference voltage. The capacitors 41, 42 attempt to maintain a potential difference of their own under a short transient condition. Therefore, at the moment when the polarity of the AC voltage Vac has been reversed at the input side of the starting circuit 12, i.e., the output side of the inverter 11, the AC voltage Vac outputted from the inverter 11 is biased by the charging voltages of the capacitors 41, 42, respectively. Namely, there are instantaneously (temporarily) generated a voltage +2V (+V is added to +V) in the output terminal 14 connected to the other end of the capacitor 41, and a voltage −V (−V is added to 0) in the output terminal 15 connected to the other end of the capacitor 42, in a case where a voltage of the one output terminal (the output terminal connected with the first polarity line 44) of the inverter 11 is a reference voltage. Accordingly, an output voltage Vout (=+3V) three times as large as the AC voltage Vac is temporarily applied to the discharge lamp 16 from the output terminals 14, 15 at the moment when the polarity of the AC voltage Vac has been reversed.

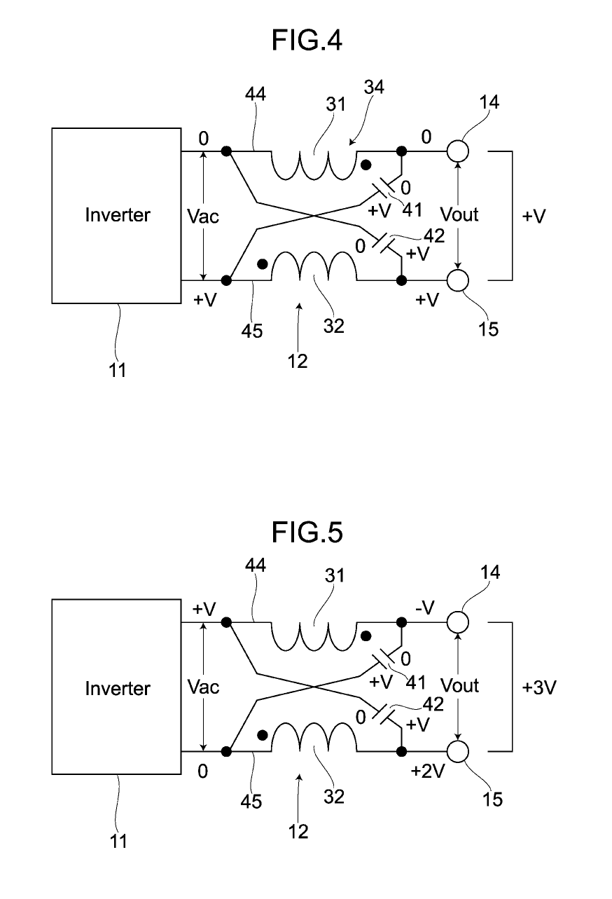

Subsequently, energy exchanges take place between the two windings 31, 32 and the two capacitors 41, 42 connected to the windings through resonance, thus allowing the output voltage Vout generated between the output terminals 14, 15 to go on attenuating while they are resonating at a constant frequency. Eventually, as shown in FIG. 4, the first capacitor 41 is charged at up to a voltage −V in a case where a voltage of its terminal connected with the second polarity line 45 is a reference voltage. Further, the second capacitor 42 is charged at up to a voltage +V in a case where a voltage of its terminal connected with the first polarity line 44 is a reference voltage.

Later, as shown in FIG. 5, when the polarity of the AC voltage Vac from the inverter 11 has been reversed again, a voltage +V is generated in the one output terminal (the output terminal connected with the first polarity line 44) of the inverter 11 with the other output terminal (the output terminal connected with the second polarity line 45) of the inverter 11 allowed to serve as a reference voltage. Even here, at the moment when the polarity of the AC voltage Vac has been reversed, the AC voltage Vac outputted from the inverter 11 is biased by the charging voltages of the capacitors 41, 42, respectively. Therefore, there is generated a voltage −V (−V is added to 0) in the output terminal 14 connected to the other end of the capacitor 41, and a voltage +2V (+V is added to +V) in the output terminal 15 connected to the other end of the capacitor 42. Accordingly, although the polarity of the AC voltage Vac has been reversed as compared to the case illustrated in FIG. 3, an output voltage Vout (=+3V) three times as large as the AC voltage Vac is still applied to the discharge lamp 16 from the output terminals 14, 15.

Subsequently, energy exchanges take place between the two windings 31, 32 and the two corresponding capacitors 41, 42 through resonance, thus allowing the output voltage Vout generated between the output terminals 14, 15 to go on attenuating while they are resonating at a constant frequency. Eventually, as shown in FIG. 2, the first capacitor 41 is charged at up to a voltage +V in a case where a voltage of its terminal connected with the second polarity line 45 is a reference voltage. Further, the second capacitor 42 is charged at up to a voltage −V in a case where a voltage of its terminal connected with the first polarity line 44 is a reference voltage.

In this way, the operations illustrated in the aforementioned FIG. 2 through FIG. 5 are repeated. As long as the AC voltage Vac with a high frequency is kept being outputted from the inverter 11, there can be continuously outputted a high voltage necessary for lighting the discharge lamp 16. For example, if the AC voltage Vac from the inverter 11 is 400 V at the time of the start, there will be applied across the discharge lamp 16 an output voltage three times as large as 400 V, i.e., an output voltage Vout of 1.2 kV. In this case, if there is used a discharge lamp 16 with a starting voltage of about 1 kV, then this discharge lamp 16 can be allowed to start discharging adequately. Once the discharge lamp 16 has started discharging, the discharge lamp 16 transfers to a steady state and thereby the frequencies of the pulse drive signals supplied to the switching elements 21 through 24 are caused to decrease, thus generating from the inverter 11 an AC voltage Vac with a frequency lower than before the transfer. Under the steady state condition, the starting circuit 12 becomes negligible as a circuit, thereby causing the AC voltage Vac from the inverter 11 to be applied substantially directly to the discharge lamp 16 through the output terminals 14, 15, thus allowing the discharge lamp 16 to be continuously lighted.

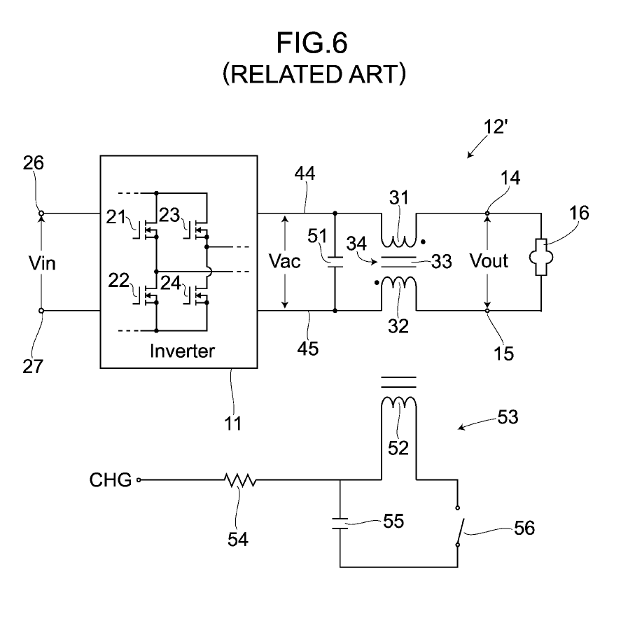

For the sake of comparison, FIG. 6 shows one example of a discharge lamp lighting device comprising the conventional starting circuit 12′. Here, a capacitor 51 is serially connected to windings 31, 32 on an input side of the starting circuit 12′. Further, a charge/discharge circuit 53, comprising a starting winding 52 electromagnetically coupled with an additive polarity transformer 34 is added to the starting circuit 12′. The charge/discharge circuit 53 is composed of a resistor 54, a trigger capacitor 55, and a switch element 56 such as a thyristor, a MOSFET or the like in addition to the starting winding 52. At the time of starting a discharge lamp 16, the charge/discharge circuit 53 allows the capacitor 55 to be charged through the resistor 54 due to a charging signal CHG externally supplied to the charge/discharge circuit 53 when the switch element 56 is in an off-state. Later, when the switch element 56 is turned on to form a closed circuit of the starting winding 52 and the capacitor 55, a trigger pulse is applied to the starting winding 52, using energy stored in the capacitor 55, thereby inducing voltages in windings 31, 32 serially connected to both the ends of the discharge lamp 16, thus applying a desired output voltage Vout to the discharge lamp 16.

Here, when the circuits shown in FIG. 1 and FIG. 6 are compared with each other, it is sufficient that the starting circuit 12 of the present embodiment is equipped with the two windings 31, 32 making up the additive polarity transformer 34 or an inductance, and the two capacitors 41, 42 connected crisscross to the two windings 31, 32, and therefore a configuration corresponding to the conventional charge/discharge circuit 53 becomes unnecessary. Further, if each of the switching elements 21 through 24 is allowed to perform the switching operations at a high frequency at the start thereof and a given AC voltage Vac is continuously applied from the inverter 11 for a given length of time, a voltage necessary for the discharge lamp 16 can be continuously outputted to the discharge lamp 16, thus improving the lighting performance of the discharge lamp 16.

As described above, in the present embodiment, the starting circuit 12 acting as the discharge lamp starting circuit connected to the inverter 11 outputs to the discharge lamp 16 the output voltage Vout capable of starting the discharge lamp 16 that is a load, upon receiving AC power with a high frequency from the inverter 11 at the start. Particularly, the starting circuit 12 comprises the first and second windings 31, 32 which are connected to the output terminals of the inverter 11 and are serially connected to the discharge lamp 16; the first capacitor 41 connected between the output terminal of said first winding 31 and the input terminal of said second winding 32; and a second capacitor connected between an input terminal of the first winding 31 and an output terminal of the second winding 32. Further, the discharge lamp lighting device comprising the inverter 11 and the starting circuit 12 has the same configuration.

Accordingly, at the moment when the polarity of the AC power supplied to the starting circuit 12 from the inverter 11 has been reversed, the capacitors 41, 42 constituting the starting circuit 12 attempt to maintain the charging voltages stored so far, thereby allowing the charged voltages +V of the capacitors 41, 42 to be added to the AC voltage Vac from the inverter 11, thus making it possible to instantaneously apply to the discharge lamp 16 the output voltage Vout higher than the AC voltage Vac. Further, since the AC power Vac is continuously applied from the inverter 11 for the given period of time, there can be continuously generated from the starting circuit 12 the output voltage Vout capable of lighting the discharge lamp 16, thus improving the lighting performance of the discharge lamp 16. Accordingly, the present invention eliminates the use of the conventional charge/discharge circuit 53, and is capable of continuously applying to the discharge lamp 16 an optimum starting waveform with a simple-enough circuit configuration with the only two capacitors 41, 42 added.

Further, in the present embodiment, the AC power output from the inverter 11 is especially selected as the rectangular AC voltage Vac switching alternately between positive and negative polarities. Accordingly, immediately after the AC voltage Vac has switched in polarity, the output voltage Vout higher than the AC voltage Vac can be applied instantaneously to the discharge lamp 16.

Furthermore, in this case, the windings 31, 32 and the capacitors 41, 42 are desirably selected so that after the AC voltage Vac has switched in polarity, both the voltage differences between the input and output terminals of each of the windings 31, 32 become zero as shown in FIG. 2 and FIG. 4, and thereafter the AC voltage Vac switches again in polarity. By suitably selecting the windings 31, 32 and the capacitors 41, 42, the capacitors 41,42 can be charged with the same voltage as the AC voltage Vac (the charged voltage +V) before the AC voltage again switches in polarity. Hence, every time the AC voltage switches in polarity, an output voltage Vout three times larger than the AC voltage Vac can be applied unfailingly and instantaneously to the discharge lamp 16.

Further, in the present embodiment, the inverter is configured so that the frequency of the AC voltage Vac output at the start of the discharge lamp 16 becomes higher than that of the voltage Vac output in the subsequent steady state of the discharge lamp 16. Hence, on the steady state of the discharge lamp 16 subsequent to the start thereof, the frequency of the AC voltage Vac from the inverter 11 decreases to enable the influence of the starting circuit 12 to be neglected, permitting the discharge lamp 16 to continue to be stably lighted.

Furthermore, in the present embodiment, the additive polarity transformer 34 is constituted by winding the windings 31, 32 around the common magnetic core 33. The additive polarity transformer 34 is constituted by wingding the windings 31, 32 not around separate magnetic cores but around the common magnetic core 33 and thereby the starting circuit 12 can be compactly formed.

However, the present invention is not limited to the present embodiment. As a matter of fact, various modified embodiments are possible within the scope of the gist of the present invention. For example, the inverter 11 serving as an output circuit is not limited to that including a full-bridge connected four switching elements 21 through 24 as in the present embodiment. Further, as described above, the same effect may be achieved with either one additive polarity transformer 34 formed by winding the windings 31, 32 around the common magnetic core 33, or two inductors formed by winding the windings around two separate magnetic cores. Furthermore, with regard to the two capacitors 41, 42, there may be used, for example, two capacitors 41 and two capacitors 42 instead of one capacitor 41 and one capacitor 42 as long as a desired capacity can be obtained. Similarly, two windings 31 and two windings 32 may be employed.

What is claimed:

1. A discharge lamp starting circuit connected with an output circuit for outputting an AC power to output to a discharge lamp an output voltage capable of starting said discharge lamp upon receiving said AC power from said output circuit, said discharge lamp starting circuit comprising:
first and second windings connected with output terminals of said output circuit and connected in series with said discharge lamp;
a first capacitor connected between an output terminal of said first winding and an input terminal of said second winding; and
a second capacitor connected between an input terminal of said first winding and an output terminal of said second winding.

2. The discharge lamp starting circuit according to claim 1, wherein said AC power is output from said output circuit as a rectangular waveform AC voltage switching alternately between positive and negative polarities.

3. The discharge lamp starting circuit according to claim 2, wherein said first and second windings and said first and second capacitors are selected so that after the switching of said AC voltage in polarity, both voltage differences between an input side and an output side of each of said first and second windings become zero and thereafter said AC voltage switches again in polarity.

4. The discharge lamp starting circuit according to claim 1, wherein said output circuit is configured so that a frequency of said AC power output at the start of said discharge lamp is higher than a frequency of said AC power output in a subsequent steady state of said discharge lamp.

5. The discharge lamp starting circuit according to claim 1, wherein said first and second windings are wound around a common magnetic core to form an additive polarity transformer.

6. A discharge lamp lighting device equipped with an output circuit for outputting an AC power, and a discharge lamp starting circuit for outputting to a discharge lamp an output voltage capable of starting said discharge lamp upon receiving said AC power from said output circuit, said discharge lamp starting circuit comprising:
first and second windings connected with output terminals of said output circuit and connected in series with said discharge lamp;
a first capacitor connected between an output terminal of said first winding and an input terminal of said second winding; and
a second capacitor connected between an input terminal of said first winding and an output terminal of said second winding.

7. The discharge lamp lighting device according to claim 6, wherein said AC power is output from said output circuit as a rectangular waveform AC voltage alternately switching between positive and negative polarities.

8. The discharge lamp lighting device according to claim 7, wherein said first and second windings and said first and second capacitors are selected so that after the switching of said AC voltage in polarity, both voltage differences between an input side and an output side of each of said first and second windings become zero and thereafter said AC voltage switches again in polarity.

9. The discharge lamp lighting device according to claim 6, wherein said output circuit is configured so that a frequency of said AC power output at the start of said discharge lamp is higher than that of said AC power output in a subsequent steady state of said discharge lamp.

10. The discharge lamp lighting device according to claim 6, wherein said first and second windings are wound around a common magnetic core to form an additive polarity transformer.
